(19) United States
(12) Patent Application Publication
(10) Pub. No.: US 2024/0140835 A1
(43) Pub. Date: May 2, 2024

(54) UPFLOW ELECTROCHEMICAL COAGULATION REACTOR AND METHOD OF REMOVING CONTAMINANT FROM WASTEWATER USING SAME

(71) Applicant: SK INNOVATION CO., LTD., Seoul (KR)

(72) Inventor: Joong Min PARK, Daejeon (KR)

(21) Appl. No.: 18/478,884

(22) Filed: Sep. 29, 2023

(30) Foreign Application Priority Data
Nov. 2, 2022 (KR) 10-2022-0144442

(51) Int. Cl. C02F 1/463; C02F 1/461

(52) U.S. Cl. CPC C02F 1/463; C02F 1/46109; C02F 2001/46123; C02F 2001/46133; C02F 2101/105; C02F 2201/46115; C02F 2201/4612

(57) ABSTRACT

According to an embodiment of the present disclosure, an upflow electrochemical coagulation reactor is provided. The upflow electrochemical coagulation reactor comprises a cathode fixed inside the reactor; at least one movable anode positioned at a predetermined distance from the cathode; a sensor configured to sense a change in the distance between the cathode and the anode; a controller configured to make the distance between the cathode and the anode constant while adapting to a change in the distance between the cathode and the anode sensed by the sensor; and a first separator and a second separator, the first separator being positioned above the second separator; and a sludge outlet being in fluid communication with the second separator for sludge delivery therebetween. By using the upflow electrochemical coagulation reactor, power-efficient removing of low-concentration contaminants present in wastewater can be performed.

### CROSS REFERENCE TO RELATED APPLICATION

The present application claims priority to Korean Patent Application No. 10-2022-0144442, filed Nov. 2, 2022, the entire content of which is incorporated herein for all purposes by this reference.

### BACKGROUND OF THE INVENTION

### 1. Field of the Invention

The present invention relates to an upflow electrochemical coagulation reactor and a method of removing contaminants from wastewater using the same.

### 2. Description of the Related Art

Electrocoagulation technology is used to coagulate and remove contaminants such as phosphorus and heavy metals present in water systems. Water treatment using electrocoagulation technology is performed by aggregation reaction between leached metals generated by dissolution of consumable electrodes and contaminants present in a water system. In this regard, recently, studies have been actively conducted on controlling a change in power required for driving a reactor according to a decrease in size due to elution of consumable electrodes and a change in a gap between electrodes.

### SUMMARY OF THE INVENTION

The present disclosure relates to an upflow electrochemical coagulation reactor and a method of removing contaminants from wastewater using the same.

In a first aspect of the present disclosure, an upflow electrochemical coagulation reactor includes: a cathode fixed inside the reactor; at least one movable anode positioned at a predetermined distance from the cathode; a sensor configured to sense a change in the distance between the cathode and the anode; a controller configured to make the distance between the cathode and the anode constant while adapting to a change in the distance between the cathode and the anode sensed by the sensor; a first separator and a second separator, the first separator being positioned above the second separator; and a sludge outlet being in fluid communication with the second separator for sludge delivery therebetween.

According to an embodiment, when there are two or more anodes, the distance between one anode and the cathode may be the same as the distance between the other anode and the cathode.

According to one embodiment, the cathode may include stainless steel (SS) or Ti.

According to an embodiment, the anode may include any one of Fe, Al, and combinations thereof.

According to an embodiment, the first separator and the second separator each may include a porous metal or ceramic.

According to an embodiment, the second separator may be conical.

According to an embodiment, the cathode and the anode may be located between the first separator and the second separator.

According to an embodiment, the reactor may further include a floating matter outlet.

According to an embodiment, the reactor may further include a gas outlet.

According to an embodiment, electric power applied to the reactor may be monopolar.

In a second aspect of the present disclosure, a method of removing contaminants in wastewater is performed using the upflow electrochemical coagulation reactor of the first aspect.

According to an embodiment, the contaminants may include phosphorus, heavy metals, organic matter, or a combination thereof.

In a third aspect of the present disclosure, an electrochemical coagulation reactor includes: a cathode fixed centrally inside an upper portion of the reactor; at least one movable anode positioned at a side of the cathode and at a distance from the cathode; a sensor configured to measure the distance between the cathode and the anode and to communicate the measured distance to a controller; the controller configured to move the at least one movable anode when the measured distance differs from a predetermined distance to make the distance between the cathode and the anode equal to the predetermined distance; and a sludge outlet being in fluid communication with a second separator for sludge delivery therebetween, wherein the cathode and the anode are positioned between the first and second separators and closer to the first separator, and wherein the second separator is positioned at a bottom portion of the reactor.

The features and advantages of the present disclosure can be more clearly understood with reference to the following detailed description and the accompanying drawings.

Prior to giving the following detailed description of the present disclosure, it should be noted that the terms and words used in the specification and the claims should not be construed as being limited to ordinary meanings or dictionary definitions but should be construed in a sense and concept consistent with the technical idea of the present disclosure, on the basis that the inventor can properly define the concept of a term to describe his or her invention in the best way possible.

According to the first aspect of the present disclosure, the reactor can be applied with a constant voltage during operation of the reactor, and the anode can be replaced without turning off the power supply of the reactor.

According to the second aspect of the present disclosure, low-concentration contaminants in wastewater can be power-efficiently removed.

### BRIEF DESCRIPTION OF THE DRAWINGS

FIG. 1 is a schematic diagram of an upflow electrochemical coagulation reactor according to an embodiment.

### DESCRIPTION OF THE EMBODIMENTS

The above and other objectives, features, and advantages of the present disclosure will be more clearly understood from the following detailed description taken in conjunction with the accompanying drawings, but the present disclosure is not limited thereto. In describing the present disclosure, when the detailed description of the relevant known technology is determined to unnecessarily obscure the gist of the present disclosure, the detailed description may be omitted.

Hereinbelow, an embodiment of the disclosure will be described in detail with reference to the accompanying drawings.

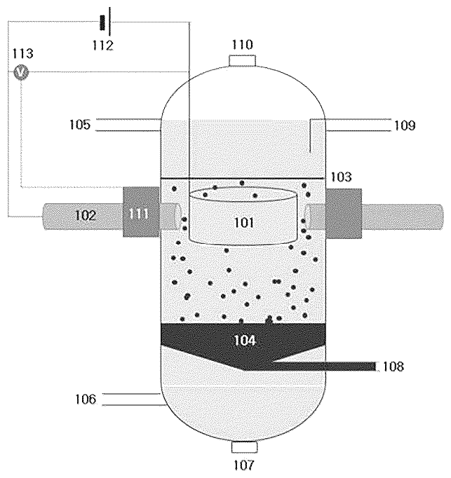

FIG. 1 is a schematic diagram of an upflow electrochemical coagulation reactor according to one embodiment.

The term “upflow” used in this specification refers to raw water flowing into a reactor upward from a lower inlet located at the bottom of the reactor. The bottom of the reactor is defined as the section of the reactor below the second separator 104.

The upflow electrochemical coagulation reactor includes a cathode 101 fixed inside the reactor and at least one movable anode 102. The anode may be positioned a predetermined distance from the cathode.

The cathode 101 is a reduction electrode that is reduced when the reactor is powered. The cathode 101 is not eluted and consumed even when the reactor is powered. The cathode is fixed at a specific position in the reactor and is not moved by a controller.

In the illustrated embodiment of FIG. 1, at least two anodes exist. The cathode is fixed at the center of the reactor as illustrated in FIG. 1 while the anodes 102 are positioned at a side of the cathode 101 so that they can be equidistant from the cathode 101. Here, the fixing method of the reactor is not particularly limited.

The cathode 101 may include a metal, and as described above, the cathode must not be eluted even when electric power is applied. The metal may be a metal having high electrical conductivity and having dissolution stability in the used electrolyte. It is not particularly limited as long as it is a metal that does not limit the purpose of the present disclosure. In terms of dissolution stability while the reactor is powered, and economy, the metal may include stainless steel (SS) or titanium Ti.

The anode is a consumable electrode that is consumed due to elution of metal ions therefrom by an oxidation reaction when the reactor is powered. The eluted metal ions form hydroxides, which act as coagulants for coagulating contaminants. Unlike the cathode fixed in the reactor, the anode extends through the outer wall of the reactor so that a part of the anode is positioned inside the reactor and the other part is positioned outside the reactor. The anode can be moved by the controller. In addition, although the anode positioned inside the reactor is completely consumed, the anode can be continuously supplied from the outside of the reactor to the inside of the reactor.

The anode may be positioned in a predetermined distance from the cathode, and the predetermined distance is a controlled distance such that a desired amount of metal ions can be eluted from the anode while electric power is applied to the reactor. Here, the predetermined distance between the anode and the cathode means the distance between the cathode and one end of the anode closest to the cathode. In an embodiment, the predetermined distance may range from 1 to 30 mm. In embodiments, the predetermined distance may range from 3 to 25 mm, and from 5 to 20 mm. When the distance between the cathode and anode is less than 1 mm, oxygen generated from the anode and hydrogen bubbles generated from the cathode may hinder the electrode-to-electrode reaction which occurs between the electrodes. When the distance exceeds 30 mm, since the resistance between the electrodes increases, the applied voltage needs to be increased, resulting in increase in power consumption.

The reactor may include at least one anode. When the reactor has two or more anodes, the two anodes are equidistant from the cathode. The same distance between each anode and the cathode is maintained so that the same voltage can be applied between each anode and cathode, which can provide convenience of management by causing uniform consumption of the anode, which is a consumable electrode.

The anode may include a metal. The metal is eluted as a metal ion when electric power is applied and is oxidized to a metal hydroxide in a water system. The metal hydroxide is crystallized when meeting each other to function as a coagulant. Any metal that acts as described above can be used as the material of the anode without particular limitations. For example, in an embodiment, the metal may include a highly reactive metal, and the metal may be any one of Fe, Al, and a combination thereof.

The reactor may include a sensor 113 that senses a change in the distance between the cathode and the anode. In an embodiment, the sensor 113 may sense a change in the distance by measuring a change in voltage applied between the cathode and the anode. When electric power is applied to the reactor, as the anode is eluted to produce metal ions, the size of the anode decreases and the distance between the cathode and the anode increases. As the distance between the electrodes increases, the voltage required to elute the anode increases. The sensor 113 can sense a change in the distance between the cathode and the anode on the basis of the voltage change.

The reactor may include a controller 111 that makes the distance between the cathode and the anode constant on the basis of a change in the distance between the cathode and the anode sensed by the sensor 113. When the distance between the cathode and the anode, which is sensed by the sensor 113, is increased by a certain percentage compared to the initially set distance before electric power is applied, the controller maintains the distance between the cathode and the anode by pushing the anode toward the cathode. Therefore, the distance between the previous cathode and anode can be maintained. In an embodiment, when the sensor 113 senses a change in the distance between the cathode and the anode on the basis of the voltage change measured, the controller may control the anode so that the voltage between the cathode and the anode is reduced. Specifically, when the controller receives a change from the sensor that the distance between the cathode and the anode is increased by 10% or more, 5% or more, and 3% or more compared to the initially set distance between the cathode and the anode before electric power is applied, the controller will make the changed distance returned to the distance that is detected before electric power is applied. In an embodiment, the controller operates in real time by receiving a change in the distance between the cathode and the anode in real time from the sensor 113. In this way, by maintaining the distance between the cathode and the anode, which is detected before electric power is applied, even though the reaction proceeds, a desired amount of metal ions may be uniformly eluted from the anode, so that an efficient aggregation reaction may be performed.

The controller is not particularly limited as long as it can insert the anode into the reactor from the outside of the reactor. In an embodiment, the controller may include a motor. The motor may be mounted on the outer wall of the reactor through which the anode passes, to provide a driving force to push the anode toward the cathode placed in the reactor. When the anode is pushed toward the cathode by the controller and is finally consumed, a new anode will be loaded on the controller while the reactor is being powered.

The reactor may include a first separator 103 and a second separator 104. The first separator and the second separator may be installed inside the reactor such that one end of each of the first and second separators 103 and 104 is parallel to the bottom of the reactor. The first separator 103 may be positioned above the second separator 104.

The first and second separators 103 and 104 may define a zone inside the reactor between them which is a bed in which a coagulant is present. Here, the coagulant is formed by crystallization of metal hydroxides made from metal ions eluted from the anode when electric power is applied to the reactor. Coagulants can form sludge by covalent or electrostatic bonding with contaminants such as phosphorus and heavy metals present in raw water while their surface is hydrated. In addition, even though the coagulant does not form sludge, while it moves from the first separator to the second separator, its size increases due to contact with other metal hydroxides, resulting in it being difficult to pass through the second separator.

The first and second separators 103 and 104 may include porous metal or porous ceramic materials. Here, the porous metal and porous ceramic materials allow transmission of only a liquid, and prevent solid components such as the coagulant, which is a hydroxide of metal ions eluted from the anode, and sludge generated by reaction between the coagulant and contaminants, from exiting through the top and bottom surfaces of the bed. The porous metal and porous ceramic may be, for example, a metal or ceramic material having pores capable of filtering out solids of a specific size and allowing transmission of only a liquid phase. The porous metal and porous ceramic materials may be in the form of a sieve or a mesh.

In an embodiment, the porous metal or porous ceramic materials may have pores with sizes ranging from 1 to 10 μm. The coagulant made from metal ions eluted from the anode has a size of several tens to hundreds of micrometers, and the coagulant and sludge produced by bonding between the coagulant and contaminants cannot pass through the top or bottom surface of the bed, i.e., through the pores of the porous metal or porous ceramic materials in the first and second separators 103 and 104.

The reactor has a sludge outlet 108, which is in fluid communication with the second separator for sludge delivery. As described above, the sludge outlet is an output port through which solid components such as the coagulant and sludge present in the bed can be discharged to the outside of the reactor. In an embodiment, since solid components are discharged through the sludge outlet, the sludge outlet may be equipped with a sludge withdrawing device.

The shape of the second separator 104 is not limited. The second separator 104 may have any shape that facilitates solid components such as coagulant and sludge, which are collected by sedimentation, to be discharged through the sludge outlet easily. For example, the second separator may have a conical shape. In this case, the coagulant and the sludge generated between the first and second separators are collected at the vertex portion of the conical second separator by settling, so that the collected coagulant and sludge can be easily discharged through the sludge outlet 108 that is in fluid communication with the vertex portion of the second separator 104.

Referring to FIG. 1, the cathode and the anodes 101 and 102 may be disposed between the first separator and the second separator 103 and 104. In an embodiment, the cathode and the anodes 101 and 102 may be positioned to be closer to the first separator 103 in the intermediate zone between the first separator and the second separator 103 and 104. By positioning the cathode and the anode 101 and 102 in an upper portion of the reactor so as to be close to the first separator 103, it is possible to prevent the metal hydroxide (i.e., coagulant) generated due to elution of the at least one anode 102 from accumulating on the surfaces of the cathode 101 and the at least one anode 102, thereby maintaining a predetermined voltage between the cathode 101 and the at least one anode 102. More specifically, since the cathode 101 and the at least one anode 102 are positioned closer to the first separator 103, metal ions eluted from the at least one anode 102 and their hydroxides are generated in an upper portion of the reactor, and the generated hydroxides descend by gravity and meet with other metal hydroxides, thereby becoming bigger aggregates. As a result, the coagulant can be concentrated in the vicinity of the second separator 104. Since the cathode 101 and the anode 102 are positioned between the first separator 103 and the second separator 104, metal ions eluted from the anode 102 can form a bed in the region defined between the first separator 103 and the second separator 104.

In the bed, the concentration of coagulant may not be uniform. Specifically, as shown in FIG. 1, the concentration of the coagulant at the bottom of the bed, that is, in the vicinity of the second separator may be extremely higher than that at the top of the bed. In addition, the concentration of the coagulant may be low in a position corresponding to the upper part of the bed, where the cathode and the anode are positioned. As described above, the non-uniformity of the coagulant concentration is caused by the action of gravity, which significantly lowers the probability that the coagulant adheres to the surfaces of the cathode and anode, enabling uniform voltage application to the cathode 101 and the at least one anode 102. This increases the probability that the coagulant particles which exist more intensively at the bottom of the bed come into contact contaminants present in wastewater flowing upward from the bottom of the reactor, thereby facilitating coagulation even in the case where the concentration of contaminants in the wastewater is extremely low.

The reactor may further include a raw water inlet 106. The raw water inlet 106 may be positioned lower than the second separator 104. Through the raw water inlet 106, raw water such as wastewater to be treated is introduced into the reactor, and the introduced raw water may pass through the second separator 104 as an upward flow. Contaminants present in the raw water can cause a coagulation reaction with the coagulant in the bed to form sludge.

The reactor may further include a floating matter outlet 105. The floating matter outlet 105 may be located above the first separator 103. During the oxidation-reduction reaction in which the metal of the anode 102 is eluted, hydrogen gas is generated at the cathode and oxygen gas is generated at the anode by a side reaction of water decomposition. The hydrogen and oxide gases may push the metal ions eluted from the anode 102 to the top of the reactor through the first separator 103. The metal ions floated to the top form a coagulant through a hydroxylation reaction, and contaminants in the raw water coagulate to form sludge. This sludge is discharged to the outside of the reactor through the floating matter outlet 105.

The reactor may further include a gas outlet 110. The gas outlet 110 is an output port which gaseous components in the reactor are discharged to the outside of the reactor. The oxygen and hydrogen gases generated from the cathode 101 and anode 102 during the aforementioned oxidation-reduction reaction may be discharged through the gas outlet 110.

The reactor may further include a treated water outlet 109. The contaminants contained in the raw water introduced into the reactor through the raw water inlet 106 are discharged through the sludge outlet 108 after undergoing a coagulation reaction in the bed, and the residual contaminants, coagulant, and sludge are discharged through the floating matter outlet 105 by electro-flotation. In addition, the oxygen and hydrogen gas generated during the oxidation-reduction reaction of the cathode and anode are discharged through the gas outlet. In this way, the raw water that is treated, i.e., treated water, may be discharged to the outside of the reactor through the treated water outlet 109. The treated water outlet 109 is equipped with a special structure that prevents floating matter existing above the first separator from being discharged to the outside of the reactor along with the treated water when the treated water is discharged. The floating matter outlet and the treated water outlet 109 also serve to maintain the water level in the reactor.

In an embodiment, the treated water outlet 109 may include a screen and may be positioned below the floating matter outlet 105. Through the treated water outlet 109 located below the floating matter outlet 105 and equipped with a screen capable of filtering out solid components, only the liquid component of the treated water containing some suspended solids is discharged to the outside of the reactor through the treated water outlet 109.

The treated water discharged through the treated water outlet 109 may have a concentration of contaminants reduced by 90% or more, 95% or more, and 99% or more, compared to the initial concentration in raw water introduced into the reactor through the raw water inlet.

The reactor may further include a drain 107. The drain may be located at the lowest point of the bottom of the reactor. Through the drain, washing water may be discharged during periodic maintenance of the reactor, or coagulant and sludge that may be present below the second separator may be discharged to the outside of the reactor.

Electric power applied to the reactor from power source 112 may be monopolar. The monopolar power application is a power application method in which one electrode has only one polarity. When multiple plate-like electrodes are aligned in parallel, in the case of a bipolar power application method in which every single intermediate electrode disposed between two outer electrodes directly connected to a power supply have a first side having a positive (+) polarity and a second side, which is opposite to the first side, has a negative (−) polarity, a significantly high voltage needs to be applied between the two outer electrodes to cause electric field on all the intermediate electrodes between the outer electrodes, and furthermore the intermediate electrodes between the outer electrodes directly connected to the power supply are consumed. However, in the case of a monopolar power application method, it is not necessary to apply a high voltage, only an electrode that is connected to the negative polarity of the power supply is consumed upon power application, and only a small amount of metal ion is eluted from the anode, which is more effectively used for removal of low-concentration contaminants.

According to one aspect of the present disclosure, a method of removing contaminant in wastewater using the above-described upflow electrochemical coagulation reactor is provided. When raw water is introduced through the raw water inlet of the above-described upflow electrochemical coagulation reactor and power is applied, an oxidation-reduction reaction occurs between the cathode and the anode, so that the metal contained in the anode is eluted in the form of ions. The eluted metal ions form a hydroxide-type coagulant, and the coagulant is dispersed between the first separator and the second separator to form a bed. Contaminants present in the wastewater introduced as an upward flow through the raw water inlet located below the second separator react with the coagulant in the bed to form sludge which is an aggregate of the coagulant and the contaminants. As the metal ions forming the coagulant are produced by oxidation of the anode, when the anode is gradually consumed, and the distance between the cathode and the anode gradually increases. When this event happens, the sensor 113 senses the change in the distance, and transmits a signal to the controller, and transmits the signal. The controller moves the anode so that the initial distance detected before power application can be maintained between the cathode and the anode, at the time of receiving at the signal from the sensor 113. The formed sludge is drawn and discharged out of the reactor through the sludge outlet.

The contaminants present in the wastewater may include phosphorus, heavy metals, organic materials, or combinations thereof. Here, the organic material may form an electrostatic bond with a hydroxide formed by hydroxylation of metal ions eluted from the anode, and thus be aggregated. That is, it may be an organic material reactive with the metal ions. In addition, the metal ions eluted from the anode have a property of forming a polymer, which forms a kind of filter in the vicinity of the second separator together with the coagulant that forms the bed. Organic matter having a high molecular weight in raw water removed by filtration of the second filter may also fall within the concept of the organic material.

Through a series of steps as described above, contaminants can be removed from wastewater. In addition, contaminants and suspended materials in the wastewater are floated by oxygen and hydrogen gas generated during oxidation-reduction reaction of the cathode and an anode, so that coagulant and sludge are generated at a position above the first separator, and discharged through the floating matter outlet.

In addition, oxygen and hydrogen gases generated from the cathode and anode may be discharged to the outside of the reactor through the gas outlet.

After removing the contaminants from the wastewater and removing gases generated during the treatment of the wastewater, the produced treated water is discharged to the outside of the reactor through the treated water outlet 109.

Herein above, the present disclosure has been described in detail with reference to specific embodiments. Embodiments are provided only for illustrative purposes, and the present disclosure is not limited thereto. It will be apparent to those skilled in the art that modifications thereto or improvements thereof are possible without departing from the technical spirit of the present disclosure.

All simple modifications and alterations of the present disclosure will fall within the scope of the present disclosure, and the specific protection scope of the present disclosure will be clearly defined by the appended claims.

What is claimed is:

1. An upflow electrochemical coagulation reactor comprising:
a cathode fixed inside the reactor;
at least one movable anode positioned at a predetermined distance from the cathode;
a sensor configured to sense a change in the distance between the cathode and the anode;
a controller configured to make the distance between the cathode and the anode constant while adapting to a change in the distance between the cathode and the anode sensed by the sensor;
a first separator and a second separator, the first separator being positioned above the second separator; and
a sludge outlet being in fluid communication with the second separator for sludge delivery therebetween.

2. The upflow electrochemical coagulation reactor of claim 1, wherein when there are two or more anodes, each of the two anodes is in an equal distance to the cathode.

3. The upflow electrochemical coagulation reactor of claim 1, wherein the cathode comprises stainless steel (SS) or Ti.

4. The upflow electrochemical coagulation reactor of claim 1, wherein the anode comprises any one of Fe, Al, and a combination thereof.

5. The upflow electrochemical coagulation reactor of claim 1, wherein the first separator and the second separator each comprises a porous metal or ceramic.

6. The upflow electrochemical coagulation reactor of claim 1, wherein the second separator is conical.

7. The upflow electrochemical coagulation reactor of claim 1, wherein the cathode and the anode are disposed between the first separator and the second separator.

8. The upflow electrochemical coagulation reactor of claim 1, wherein the reactor further comprises a floating matter outlet.

9. The upflow electrochemical coagulation reactor of claim 1, wherein the reactor further comprises a gas outlet.

10. The upflow electrochemical coagulation reactor of claim 1, wherein electric power applied to the reactor is monopolar.

11. A method of removing contaminants from wastewater using the upflow electrochemical coagulation reactor of claim 1.

12. The method of claim 11, wherein the contaminants comprise phosphorus, heavy metals, organic matter, or a combination thereof.

13. An electrochemical coagulation reactor comprising:
a cathode fixed centrally inside an upper portion of the reactor;
at least one movable anode positioned at a side of the cathode and at a distance from the cathode;
a sensor configured to measure the distance between the cathode and the anode and to communicate the measured distance to a controller;
the controller configured to move the at least one movable anode when the measured distance differs from a predetermined distance to make the distance between the cathode and the anode equal to the predetermined distance; and
a sludge outlet being in fluid communication with a second separator for sludge delivery therebetween,
wherein the cathode and the anode are positioned between the first and second separators and closer to the first separator, and
wherein the second separator is positioned at a bottom portion of the reactor.
